(19) United States
(12) Patent Application Publication
(10) Pub. No.: US 2012/0292330 A1
(43) Pub. Date: Nov. 22, 2012

(54) Package Having Three Dimensional Label and Production Method Thereof

(76) Inventor: Hasan Hakan Artun, Istanbul (TR)

(21) Appl. No.: 13/575,934

(22) PCT Filed: Feb. 1, 2011
(86) PCT No.: PCT/IB2011/050438

§ 371 Date: Jul. 27, 2012

(30) Foreign Application Priority Data
Feb. 2, 2010 (TR) 2010/00724
Jan. 26, 2011 (TR) 2011/00731

(51) Int. Cl. B65D 25/54; B29D 11/00

(52) U.S. Cl. 220/662; 264/1.7

(57) ABSTRACT

The present invention relates to a package (100) having three dimensional label and production method (PM1, PM2) thereof. The package (100) comprises at least one inner surface (104) which is in contact with the product intended to be stored, at least one outer surface (102) having a lens surface formed by injecting via pressure transparent plastic raw material on the female mould (FML) where the lens design is machined inversely or by placing the lenticular lens prepared outside as a label into the mould (FM) and at least one graphic located between the inner surface (104) and the outer surface (102).

### FIELD OF THE INVENTION

The present invention relates to a package having three dimensional label and production method thereof.

### BACKGROUND OF THE INVENTION

Nowadays, lenticular lenses (3 dimensional lenses) are used in advertisement sector particularly in advertisement and promotion products. In the advertisement sector, production of three dimensional visual effects named as lenticular lenses (biconvex lens)/3D (3 dimensional) labels and used particularly as advertisement and promotion products is in the form of a plate or a sheet produced from a plastic material whose one surface is composed of lenticular lenses. Production in the form of plates is carried out only in flat floor applications due to the fact that the lens surface is in the form of a plate.

Lenticular lens printing technique is the system of producing a plurality of images on a surface by changing angles by the help of lenses serving as lenticula (lenticular) on a transparent plate made of plastic material. Three dimensional images designed by specific computer software and method are directly transferred on a plastic based film sheet (IML label) used as a label or a paper (to be subsequently plastered on the plastic plate, a surface of which has lens) or on the other surface of the plate, a surface of which has lens, by means of various printing techniques (serigraphy, offset, digital printing, etc.).

The U.S. Pat. No. 6,065,623 and U.S. Pat. No. 6,394,293 disclose plastic closures which are particularly used in bottles of carbonated beverages and water. The said documents mention about determining the recess named as rabbet applied on plastic closures as the label seat, and firmly locking and adhering to the seat, where the rabbet is located, a lenticular lens plate prepared as an insert upon cutting with the same size outside, by means of connection apparatuses.

As seen from the said patent documents, Lenticular Lens applications where there are provided 3 dimensional effects on bottle closures are known in the state of the art. The said known method serves for the advertisement and promotion sector in respect of its scope. These methods in the said documents can not provide a solution to the packaging industry, which require different production processes for different size—model and high production quantities, for application of a 3 dimensional label, especially in terms of their costs.

In retail sector where there is fierce competition, the state of the art should be improved and production should be realized with suitable production methods specific for each model, in order to produce the packages which make a difference in presentation and sale of brands and the containers and/or closures on whose label regions there are three dimensional labels, in high amounts and with suitable costs.

### SUMMARY OF THE INVENTION

The objective of the present invention is to provide a package having three dimensional label and production method thereof, where, in the production process of the containers and/or closures used in the packaging industry, the lens surface at the label regions and the labels which are provided three dimensionality by means of the lenticular printing technique are produced together.

Another objective of the present invention is to provide a package having three dimensional label such as containers and/or closures with 3 D (3 dimensional) labels and production method thereof by applying the lens surface on the surface of the containers and/or closures themselves.

### DETAILED DESCRIPTION OF THE INVENTION

The “Package having three dimensional label and production method thereof” developed to fulfill the objective of the present invention is illustrated in the accompanying figures wherein,

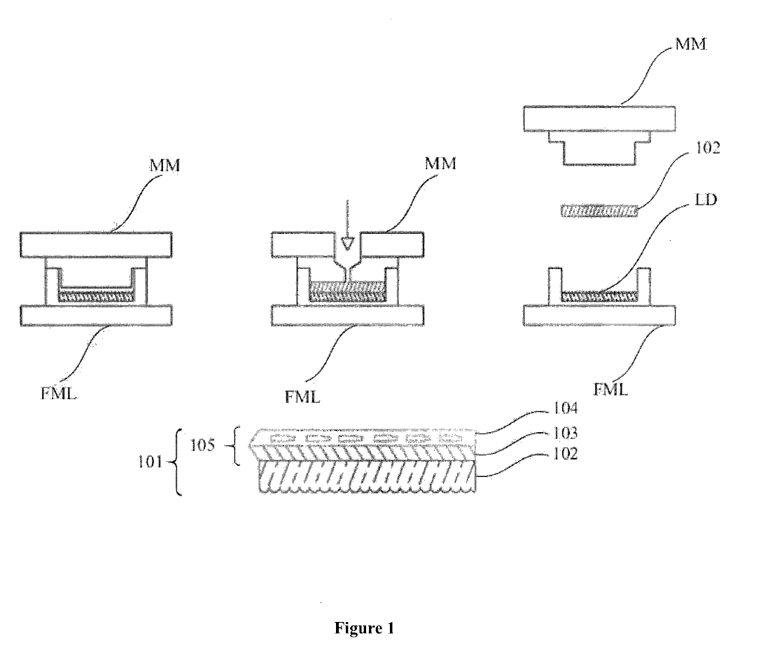

FIG. 1 is the view of the production of the package with lens surface by injecting transparent plastic material to the female mould on which the lens surface is machined inversely as a design.

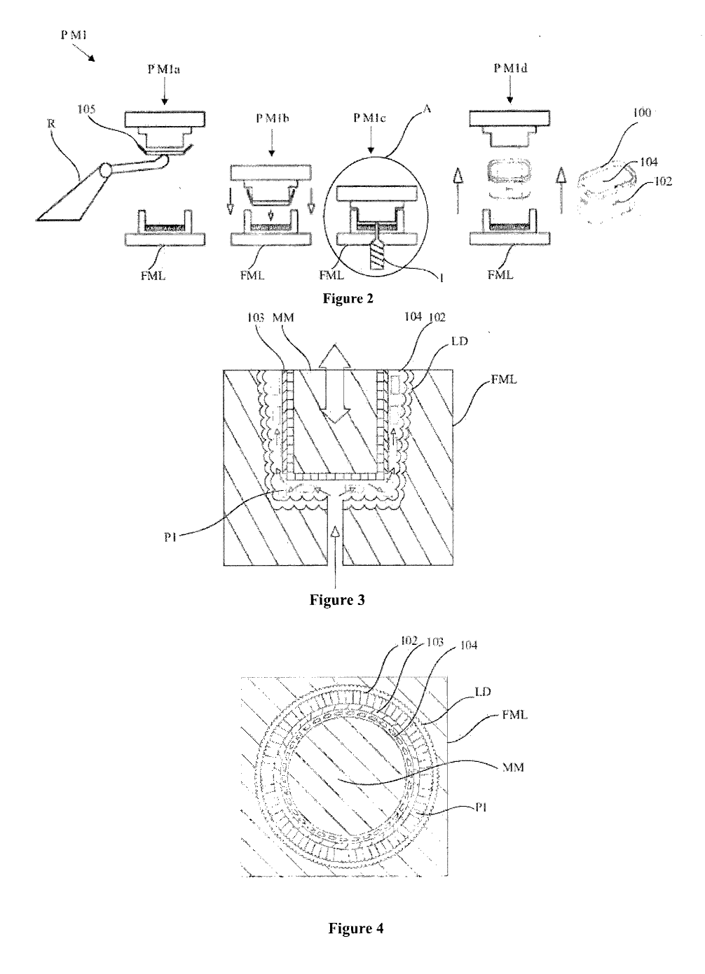

FIG. 2 is the view of the production (PM-1) of a package with lens surface and label, as a result of the female mould, on which the lens surface is machined as a design, wrapping the label that includes the image onto the male mould, which corresponds to the female mould and forms the inner region of the package, by means of a robot specially programmed for each model, and the transparent plastic raw material being injected to the mould.

FIG. 3 is the view of detail A shown in FIG. 2.

FIG. 4 is the top view of FIG. 2.

FIG. 5 is the view of the production (Production Method 2/PM-2) of the package as a result of producing outside and cutting the lens plate, which is prepared with the printing of the production forming the image in the label design, in accordance with the stencil in the determined size and model, and placing it in the female mould as an insert by means of a robot specially programmed for each model, providing the plastic raw material thereon and pressing with the male mould (MM).

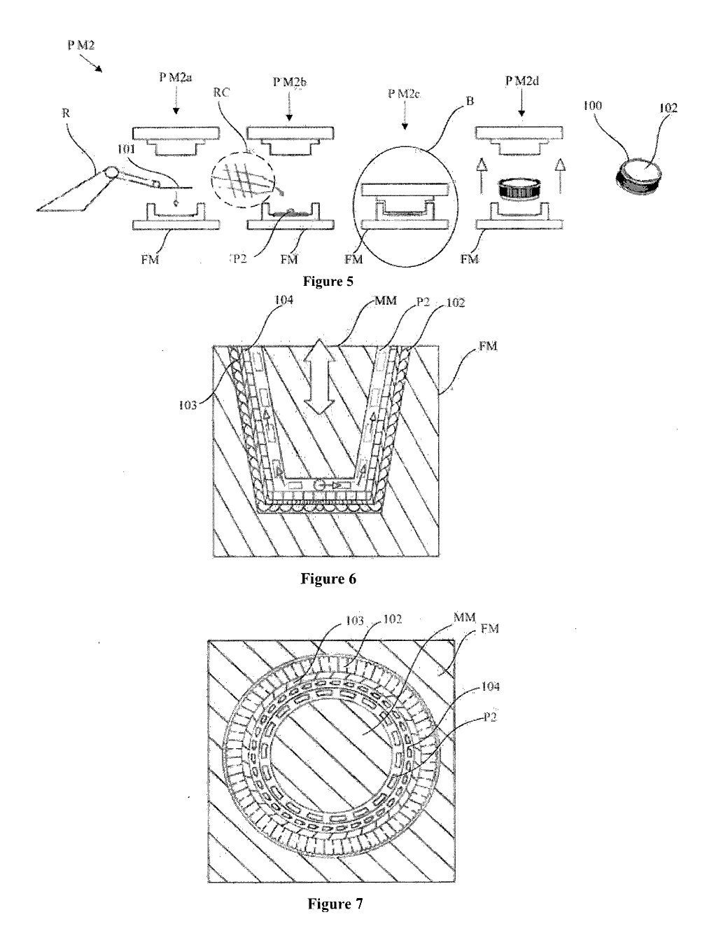

FIG. 6 is the view of detail B shown in FIG. 5.

FIG. 7 is the top view of FIG. 5.

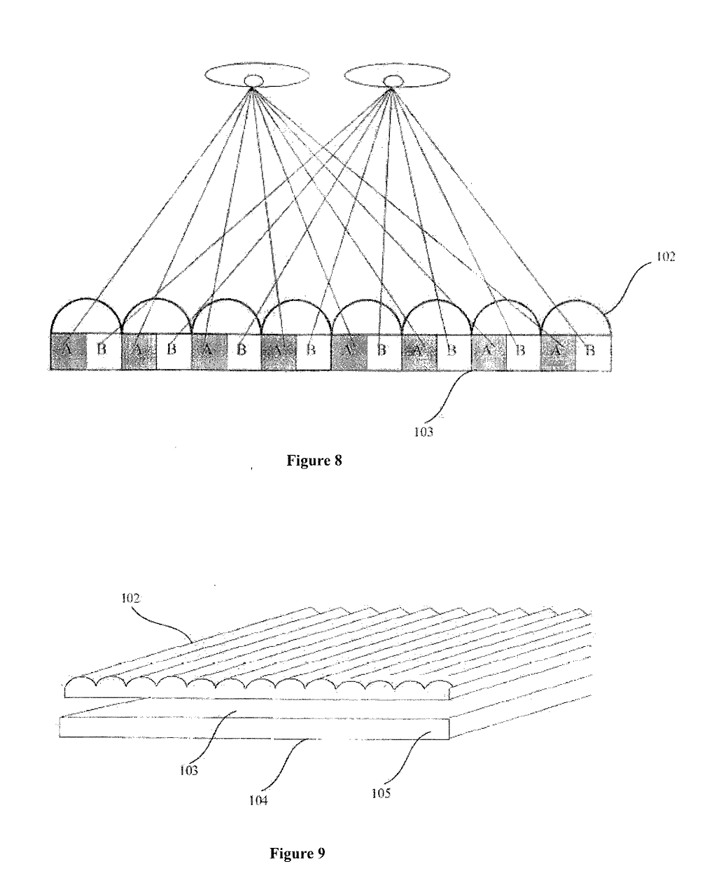

FIG. 8 is the sectional view of the lens surface on which the production sheet is applied.

FIG. 9 is the view of the lens surface on which the production sheet is applied.

The components in the figures are each given a reference number and these numbers refer to the following:
100: Package
101: Label with lens design
102: Outer surface
103: Graphic
104: Inner surface
105: Printed label
MM: Male mould
FM: Female mould
FML: Female mould on which the lens design is inversely machined
LD: Steel lens design inversely machined inside the female mould
PM1: Method of producing package via injection.
P1: Transparent plastic raw material which forms the lens surface.
R: Robot (mechanism) providing in-mould labeling
I: Injection with high heat and pressure
PM2: Method of producing package via compression.
P2: Plastic raw material
RC: Rotary compression moulding
A,B: Layer

The package (100) comprises
at least one inner surface (104) which is in contact with the product intended to be stored,
at least one outer surface (102) having a lens surface formed by injecting via pressure transparent plastic raw material on the female mould (FML) where the lens design is machined inversely or by placing the lenticular lens prepared outside as a label into the mould (FM) and
at least one graphic (103) located between the inner surface (104) and the outer surface (102).

In the inventive package (100), the inner surface (104) and the graphic (103) provided on the inner surface (104) are used as printed label (105). The printed label (105) is the plastic based IML (In-mould labeling) label which is printed to be plastered on the transparent lens plate.

In another preferred embodiment of the invention, the printed label (105) is used as the production sheet. The production is transferred onto the sheet by being separated into layers (A,B).

The production sheet is transferred to the outer surface (102) as being lenticular printed (3 dimensional). The production sheet is formed by all kinds of serigraphy, offset printing, digital printing or transfer printing.

In the preferred embodiment, lenticular printed production sheet is applied on the lens surface (102) during production of packages (100) such as containers and/or closures with the plastic injection machine by in-mould labeling (IML).

In another preferred embodiment, lenticular printed production sheet is transferred to the outer surface (102) and thus to the package (100) by way of adhesion. During adhesion process, techniques such as ultrasonic, frequency or hot printing are used.

In one embodiment of the invention, the production sheet is applied on the outer surface (102) by paper transfer to be subsequently plastered on the surface (3). In another embodiment of the invention, the production sheet is transferred to the outer surface (102) by way of in-mould labeling (IML). Plastic based label material is used for in-mould labeling.

In another embodiment of the invention, the production sheet is applied on the outer surface (102) via serigraphy.

In a further embodiment of the invention, the production sheet is applied on the outer surface (102) via digital and pad printing.

The inner surface (104), the graphic (103) on the inner surface (104) and the outer surface (102) with lens design on the graphic (103) form the label (101) with lens design. The label (101) with lens design is prepared by lenticular printing technique. The inner surface (104) also assumes the function of protecting the graphic (103).

In the preferred embodiment of the inventive package (100), the outer surface (102) is a transparent lens whose one surface is a printing area.

In the preferred embodiment of the invention, the graphic (103) is prepared by lenticular printing technique and is transferred to the inner surface (104) via serigraphy, offset, digital printing techniques.

For obtaining different models of the inventive package (100) having forms and depths of different sizes, the method of
production (PM1) of the package (100) such that outer surface (102) thereof has lens design by means of the transparent plastic raw material (P1) being injected to and contacting the inverse lens design machined to the female mould (FML) or
production (PM2) of the package (100) by placing the lenticular lens which is prepared outside as a label (101) into the female mould (FM) by a robot (R) as an insert via using in-mould labeling (IML) method and by providing thereon the plastic raw material (P2) that wick form the inner surface.
   is used.

The method (PM1), which is used in the production of the package (100) such that a lens design is provided to the outer surface (102) thereof, comprises the steps of
plastic based (IML) label (105), which is prepared by lenticular printing technique, being wrapped over the male mould (MM) (PM1-a),
the male mould (MM) which forms the inner surface (104) and also the printing surface of the package (100) being closed over the female mould (FML) with the lens design (PM-1b),
providing the packaging material in between the male mould (MM) over which the label (105) is wrapped and the female mould with lens design (FML) (PM1-c),
producing the package (PM1-d) by the lens design being formed on the outer surface (102) and the fluid plastic raw material (P1) forming the inner surface upon bonding to the label (105) on the male mould (MM). (FIG. 2)

In the inventive method, prior to production of the package (100), the lens design is inversely machined to the female mould (FM) and the mould (FM) is transformed to a female mould with lens design (FML).

In the said method (PM1), the lens design serving as lenticula is inversely machined to the label region in the female mould (FML) which is used in production of the containers and closures and which forms the outer surface (102) of the package. The said label region may be the entire package (100) as well as a determined region. The machined region is contacted by the transparent plastic raw material (P1) with high heat and pressure, whereby the outer surface (102) of the package is produced as having a lenticular lens surface.

During formation of the lenticular lens surface (102) by the female mould (FML) by means of injection of the transparent plastic raw material (P1), the distance between the male mould (MM) forming the inner surface of the package and the female mould (FML) determines the thickness of the package.

In the method (PM1), at the same time with the formation of lenticular lens design on the outer surface (102) of the package (100) by the female mould (FML), a labeled inner surface is formed (PM-1d) by wrapping (PM1-a), by the help of a robot (R), a plastic based IML label (105) with a visual production on the male mould (MM) that forms the inner surface of the package (100) and by injecting (PM1-c) plastic in between the male mould (MM) and female mould (FML). As a result of the said process, an outer surface (102) having a lenticular lens surface and an inner surface (104) on which is located the label (105) that provides the image are produced together. (FIG. 2)

Production of the inventive package (100) such that the outer surface (102) thereof includes lens design (PM1) is the method that is preferred for production of packaging materials comprising containers, cups, boxes and closures of these which are used in packaging of frozen food, dry food, liquid food, dairy products, and products of chocolate and confectionery sectors together with cosmetic and chemical sector products and which are of different models and forms particularly having transparent and thin walled surfaces.

The method (PM2) used for production of the package (100); which includes the material, which forms the outer surface at the label region, and one surface of which is a lens, together with the label (101) that is obtained by providing three dimensionality by means of the lenticular printing technique on the other surface of the material; comprises the steps of
cutting the label (101) with lens design, which is prepared by performing production printing outside, in accordance with the package (100) form,
placing the cut label (101) into the female mould (FM) that forms the outer surface (102) of the package (100) (PM2-a),
providing the plastic raw material (P2) that forms the package (100) on the label (101) that is placed into the female mould (FM) (PM2-b),
the plastic raw material (P2) being compressed by the male mould (MM) which forms the inner surface (104) of the package (100) (PM2-c), and
at the end of compression, obtaining (PM2-d) the package (100) upon removing the female mould (FM) from the male mould (MM). (FIG. 3)

In the said method (PM-2), the lens plate prepared outside by means of lenticular printing technique, is prepared as a label (101) by being cut in accordance with the form of the package (100). The said label (101) is placed into the female mould (FM) by means of a robot (R) (PM2-a). The label (101) is placed into the female mould (FM) according to the form and model of the package (100), by being folded in some of them. As a result of compression (PM2-c) of the packaging raw material (P2), which is applied with a certain heat onto the label (101) in the female mould (FM), by the male mould (MM) forming the inner surface (104) of the package (100), the label (101) and the raw material (P2) are bonded to each other and the package (100) is produced. (FIG. 3)

The raw material used in the said method is an opaque colored raw material that forms the inner surface (104) for packages (100) whose surfaces are not transparent.

In the method (PM2), firstly, the material with a lens surface whose production printing is realized is cut in accordance with the stencil in the determined size and model and prepared as label (101). The label (101) prepared according to the form of the package (100), is placed into the female chamber (FM) of the mould in order to form the outer surface (102) of the package (PM2-a).

The said method (PM2) is, just like in the production method of the package with lens design by the injection method, based on in-mould labeling principle. It is applicable for especially opaque colored packages on whose outer surfaces lens design can not be applied since their surfaces are not transparent. The method (PM2), which is used in production of packages as a result of compression of lenticular lens prepared outside as a label (101), is employed in the production of packaging materials comprising containers, cups, jars, boxes, bottles and closures of these which are used in packaging of the products in the frozen food, dry food, liquid food, dairy products, carbonated beverages, water, alcoholic and non-alcoholic drinks and chocolate and confectionery sectors together with cosmetic and chemical sectors and which are of different models and forms particularly having thin walled and opaque-colored surfaces which are not transparent.

The method (PM-2) is basically applied in plastic injection machine systems operating with high pressure. The machine, which is used to meet productions of high amounts of containers, cups, jars, boxes and bottles, locked and unlocked closures used in the sectors of frozen food, dry food, liquid food, dairy products, carbonated beverages, water, alcoholic and non-alcoholic drinks and chocolate and confectionery together with cosmetic and chemical sectors, is a machinery which operates vertically and rotatively, includes moulds of one closure on the plurality of stations situated thereon, and is known as rotary compression moulding. During production, the packaging raw material (P2) is taken into the female mould (FM) (PM2-b) by means of the method of cutting from the extruder nozzle and the package is obtained (PM2-d) by compressing the raw material (PM2-c).

In the process of placing the label (101) into the female mould (FM) (PM2-a), a robot mechanism (R), which operates synchronously by the drive force of the system, complies with the same rotative assembly and follows the same route, is incorporated to the station just before the cutting and goods reception station of the machine system. With the said mechanism incorporated to the machine system, the label (101) is placed into the female mould (FM) (PM2-a).

Within the framework of this basic concept, it is possible to develop various embodiments of the inventive package having three dimensional label and production method thereof. The invention can not be limited to the examples described herein and it is essentially according to the claims.

1. A method (PM1), used in the production of the package (100) such that a lens design is provided to the outer surface (102) thereof, and characterized by the steps of:
plastic based (IML) label (105), which is prepared by lenticular printing technique, being wrapped over the male mould (MM) (PM1-a),
the male mould (MM) which forms the inner surface (104) and also the printing surface of the package (100) being closed over the female mould (FML) with the lens design (PM-1b),
providing the packaging material in between the male mould (MM) over which the label (105) is wrapped and the female mould with lens design (FML) (PM1-c),
producing the package (PM1-d) by the lens design being formed on the outer surface (102) and the fluid plastic raw material (P1) forming the inner surface upon bonding to the label (105) on the male mould (MM).

2. A method (PM1) according to claim 1, characterized in that, in machining into the female mould (FM) the lens design intended to be provided on the package (100), the lens design serving as lenticula is inversely machined to the label region in the female mould (FML) which is used in production of the containers and closures and which forms the outer surface (102) of the package.

3. A method (PM1) according to claim 1, characterized in that, in the step of providing the packaging material in between the male mould (MM) over which the label (105) is wrapped and the female mould (FML) (PM1-c), the outer surface (102) of the package is produced as having a lenticular lens surface by enabling the transparent plastic raw material (P1) to contact the female mould (FML) with high heat and pressure.

4. A method (PM1) according to claim 1, characterized in that, at the same time with the formation of lenticular lens design on the outer surface (102) of the package (100) by the female mould (FML), a labeled inner surface is formed (PM-1d) by wrapping (PM1-a), by the help of a robot (R), a plastic based IML label (105) with a visual production on the male mould (MM) that forms the inner surface of the package (100) and by injecting (PM1-c) plastic in between the male mould (MM) and female mould (FML).

5. A method (PM2), used for production of the package (100); which includes the material, which forms the outer surface at the label region, and one surface of which is a lens, together with the label (101) that is obtained by providing three dimensionality by means of the lenticular printing technique on the other surface of the material; and characterized by the steps of
cutting the label (101) with lens design, which is prepared by performing production printing outside, in accordance with the package (100) form,
placing the cut label (101) into the female mould (FM) that forms the outer surface (102) of the package (100) (PM2-a),
providing the plastic raw material (P2) that forms the package (100) on the label (101) that is placed into the female mould (FM) (PM2-b),
the plastic raw material (P2) being compressed by the male mould (MM) which forms the inner surface (104) of the package (100) (PM2-c), and
at the end of compression, obtaining (PM2-d) the package (100) upon removing the female mould (FM) from the male mould (MM).

6. A method (PM2) according to claim 5, characterized in that, in the step of placing the cut label (101) into the female mould (FM) that forms the outer surface (102) of the package (100) (PM2-a), the label (101) is placed into the female mould (FM) by means of a robot (R).

7. A package (100) characterized by
at least one inner surface (104) which is in contact with the product intended to be stored,
at least one outer surface (102) having a lens surface formed by injecting via pressure transparent plastic raw material on the female mould (FML) where the lens design is machined inversely or by placing the lenticular lens prepared outside as a label into the mould (FM) and
at least one graphic (103) located between the inner surface (104) and the outer surface (102).

8. A package (100) according to claim 7, characterized by a plastic based IML printed label (105), which has the inner surface (104) and the graphic (103) provided on the inner surface (104), and which is printed to be plastered.

9. A package (100) according to claim 8, characterized by the printed label (105), which is used as the production sheet and where the production is transferred onto the sheet by being separated into layers (A,B).

10. A package (100) according to claim 9, characterized by the outer surface (102), onto which the lenticular printed production sheet is transferred via adhesion.

11. A package (100) according to claim 7, characterized by a label (101) with lens design which is prepared by lenticular printing technique and which comprises an inner surface (104), a graphic (103) on the inner surface (104) and an outer surface (102) with lens design located on the graphic (103).

12. A package (100) according to claim 7, characterized by the outer surface (102), which is a transparent lens whose one surface is used as the printing area.

13. A package (100) according to claim 7, characterized by the graphic (103) which is prepared by lenticular printing technique and which is transferred to the inner surface by means of serigraphy, offset, digital printing techniques.

14. A method (PM1) according to claim 2, characterized in that, in the step of providing the packaging material in between the male mould (MM) over which the label (105) is wrapped and the female mould (FML) (PM1-c), the outer surface (102) of the package is produced as having a lenticular lens surface by enabling the transparent plastic raw material (P1) to contact the female mould (FML) with high heat and pressure.

15. A method (PM1) according to claim 2, characterized in that, at the same time with the formation of lenticular lens design on the outer surface (102) of the package (100) by the female mould (FML), a labeled inner surface is formed (PM-1d) by wrapping (PM1-a), by the help of a robot (R), a plastic based IML label (105) with a visual production on the male mould (MM) that forms the inner surface of the package (100) and by injecting (PM1-c) plastic in between the male mould (MM) and female mould (FML).

16. A method (PM1) according to claim 3, characterized in that, at the same time with the formation of lenticular lens design on the outer surface (102) of the package (100) by the female mould (FML), a labeled inner surface is formed (PM-1d) by wrapping (PM1-a), by the help of a robot (R), a plastic based IML label (105) with a visual production on the male mould (MM) that forms the inner surface of the package (100) and by injecting (PM1-c) plastic in between the male mould (MM) and female mould (FML).

17. A method (PM1) according to claim 14, characterized in that, at the same time with the formation of lenticular lens design on the outer surface (102) of the package (100) by the female mould (FML), a labeled inner surface is formed (PM-1d) by wrapping (PM1-a), by the help of a robot (R), a plastic based IML label (105) with a visual production on the male mould (MM) that forms the inner surface of the package (100) and by injecting (PM1-c) plastic in between the male mould (MM) and female mould (FML).

18. A package (100) according to claim 10, characterized by a label (101) with lens design which is prepared by lenticular printing technique and which comprises an inner surface (104), a graphic (103) on the inner surface (104) and an outer surface (102) with lens design located on the graphic (103).

19. A package (100) according to claim 8, characterized by the outer surface (102), which is a transparent lens whose one surface is used as the printing area.

20. A package (100) according to claim 8, characterized by the graphic (103) which is prepared by lenticular printing technique and which is transferred to the inner surface by means of serigraphy, offset, digital printing techniques.
